(19) United States
(12) Patent Application Publication
(10) Pub. No.: US 2014/0029098 A1
(43) Pub. Date: Jan. 30, 2014

(54) BINOCULAR GOGGLES

(71) Applicant: Vickie J. Cusimano, Florissant, CO (US)

(72) Inventor: Vickie J. Cusimano, Florissant, CO (US)

(21) Appl. No.: 13/950,695

(22) Filed: Jul. 25, 2013

Related U.S. Application Data
(60) Provisional application No. 61/676,230, filed on Jul. 26, 2012.

(51) Int. Cl. G02B 23/18

(52) U.S. Cl. CPC G02B 23/18
USPC 359/481

(57) ABSTRACT

Binocular goggles are described. Embodiments of binocular goggles according to the present invention include two monocular units installed on a relatively high volume goggle body. The goggle body includes a single interior cavity configured to enclose both of a user's eyes. The interior cavity provides ample volume and airflow to reduce or eliminate condensation on lenses residing inside the goggle body. The goggle body also includes a relatively large perimeter configured to contact a user's face. The large contact perimeter typically resides against the user's face on the forehead and below the lower eye orbit, which results in a comfortable distribution of force that facilitates wearing the goggles for relatively long time intervals of an hour or more.

### CROSS-REFERENCE TO RELATED APPLICATIONS

This application claims priority to and incorporates by reference, U.S. provisional patent application No. 61/676,230, filed Jul. 26, 2012, and having the same title and inventor as the present application.

### BACKGROUND

Magnifying goggles and similar devices that magnify images of relatively distant objects are known. However, existing devices tend to suffer from one or more of the following drawbacks. Known devices are frequently cumbersome, being heavy and/or including relatively long optics that project far from a user's face. The devices often include contact perimeters that press against a user's eye orbits, which can result in significant discomfort, particularly where the device is heavy and/or cumbersome.

Prior art devices furthermore have separate, relatively low volume cavities for each of a user's eyes. The devices typically have poor airflow within each low volume cavity, and are susceptible to condensation on lenses (fogging). In addition, the devices are often incompatible with concurrent use of eyeglasses.

### BRIEF DESCRIPTION OF THE DRAWINGS

FIG. 1 is a front, perspective view of binocular goggles according to an embodiment of the present invention.

FIG. 2 is a front, perspective view of the goggle body of binocular goggles according to an embodiment of the present invention.

FIG. 3 is a front, perspective view of binocular goggles according to an embodiment of the present invention.

FIG. 4 is a right side, perspective view of binocular goggles according to an embodiment of the present invention.

FIG. 5 is a back, perspective view of binocular goggles according to an embodiment of the present invention.

FIG. 6 is a back, plan view of binocular goggles according to an embodiment of the present invention.

### DETAILED DESCRIPTION

Embodiments of binocular goggles according to the present invention include two monocular units installed in or on a relatively high volume goggle body. The goggle body includes a single interior cavity configured to enclose both of a user's eyes. The interior cavity provides ample volume and airflow to reduce or eliminate condensation on lenses residing inside the goggle body. The goggle body also includes a relatively large perimeter configured to contact a user's face. The large contact perimeter typically resides against the user's face on the forehead and below the lower eye orbit, which results in a comfortable distribution of force that facilitates wearing the goggles for relatively long time intervals of an hour or more.

Embodiments of monocular units comprise image transfer assemblies including, but not limited to, porro prism systems (including multiple porro prism systems and reverse porro prism systems), roof prism systems, and reflex mirror systems. Variations include monocular units comprising or based on Bushnell® Xtra-Wide 4×30 optics that provide a field of vision of 900 feet at a distance of 1000 yards.

During typical operation, binocular goggles of the present invention permit a user to comfortably view magnified images of distant objects and activities for long periods of time, while keeping both hands free, and without suffering arm fatigue from holding conventional binoculars.

Embodiments typically have an exit pupil of at least 3.75 millimeter (mm). The exit pupil is preferably at least 3.75 mm, more preferably 3.75 mm to 8.0 mm, and most preferably 6.0 mm-7.5 mm.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional or relational terms such as “top,” bottom,” “front,” “back,” “above,” and “below,” as used in this specification and appended claims, refer to relative positions of identified elements, components, or objects, in binocular goggles or components thereof, where the goggles or components are oriented as normally worn by a user in an upright position.

### First Embodiment Binocular Goggles

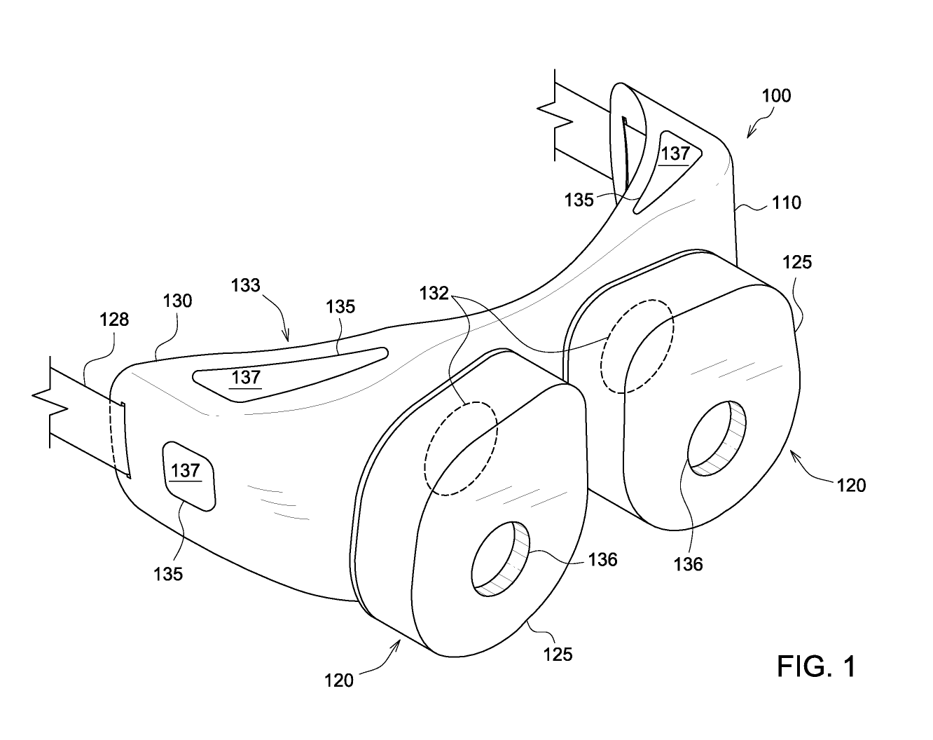

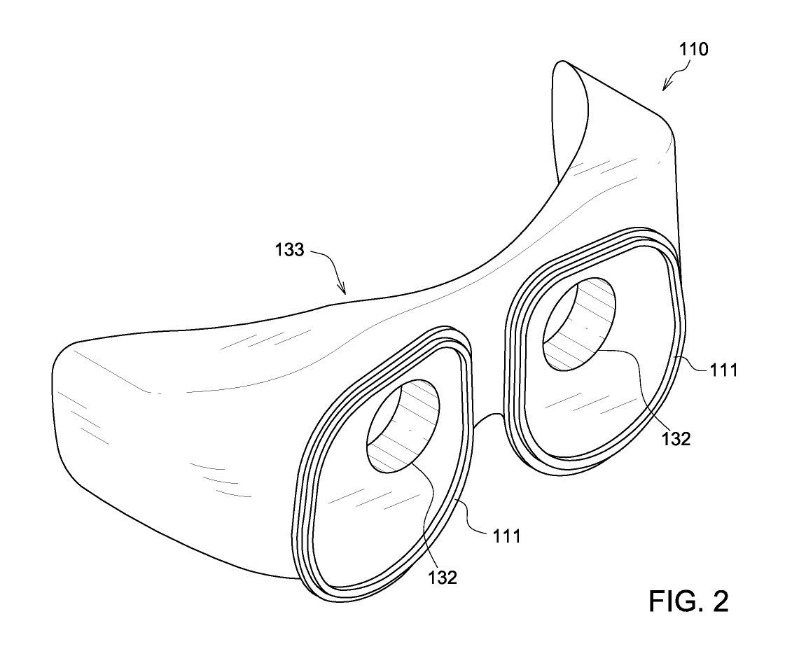

First embodiment binocular goggles 100 are illustrated in FIGS. 1 and 2, with only a goggle body 110 illustrated in FIG. 2. The first embodiment binocular goggles comprise the goggle body 110, into which are installed two monocular units 120. The goggles 100 further comprise an elastic, adjustable, head strap 128. The goggle body 110 includes a contact perimeter 130 configured to rest or press against a user's face. The contact perimeter 130 typically comprises a flexible polymer configured to flex in order to conform to a user's face. The contact perimeter 130 typically circumscribes a relatively large area, and thus typically contacts the user's face above the user's eyebrows and across the cheekbones. Contact of the contact perimeter against the user's face is thus generally outside the eye orbits, which results in greater user comfort. The first embodiment binocular goggles are configured to provide adequate room to be worn over a user's eyeglasses.

The goggle body 110 typically includes vents 135 to facilitate air exchange that reduces or eliminates fogging of a lens residing within the goggle body 110. The vents 135 in the goggle body 110 can include a foam screen 137 or other air permeable cover to help exclude debris from within the goggle body.

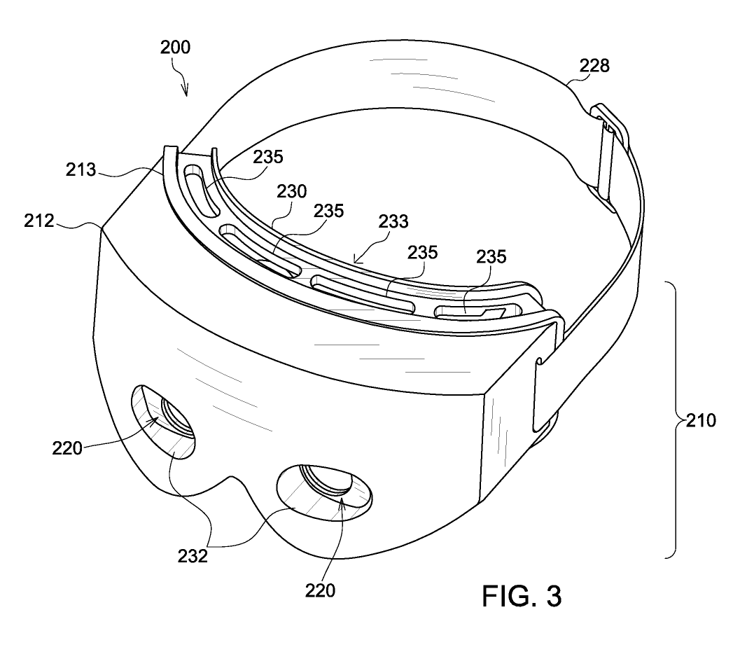

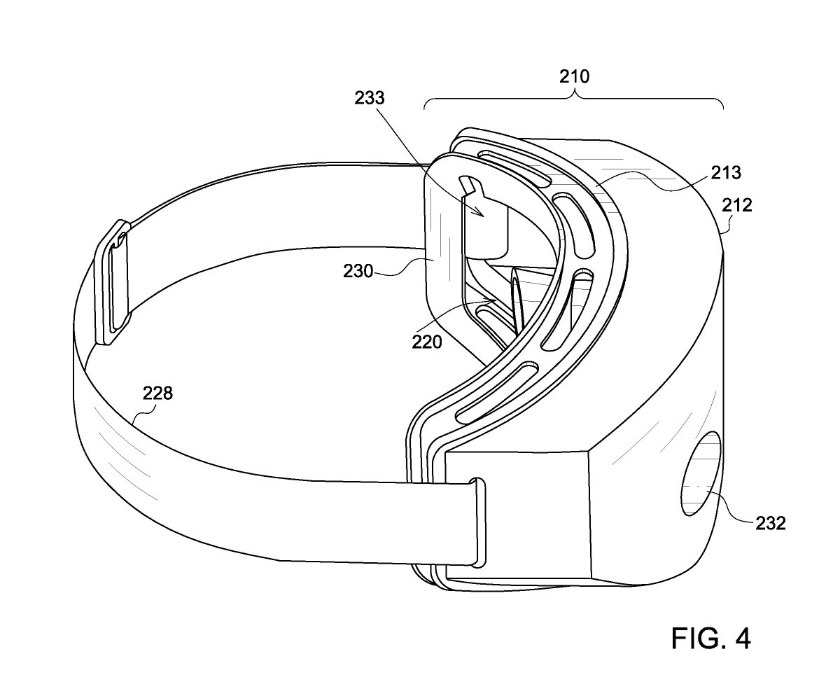

The first embodiment binocular goggles include two monocular units 120, each of which comprises an image transfer assembly 125 and an ocular assembly. The ocular assembly for the first embodiment binocular goggles is not shown, but a second embodiment ocular assembly 226 is illustrated in FIGS. 3-6. The monocular units 120 of the first embodiment consist essentially of Bushnell® Xtra-Wide 4×30 optics, including a porro prism based image transfer assembly utilizing BaK-4 prism glass. The image transfer assembly 125 of the monocular unit 120 typically extends outwardly about 30 mm in front of the goggle body 110. The ocular assembly of each monocular unit 120 extends from the image transfer assembly into a goggle interior cavity 133, and an optical path from each image transfer system 125 to its respective ocular assembly extends through a goggle body port 132. Image inlet openings 136 provide an optical path into each image transfer assembly 125.

A goggle volume consists of a volume of space residing within the goggle body interior 133. The contact perimeter 130 defines a boundary of the goggle interior cavity. The goggle volume of the first embodiment binocular goggles is preferably at least about 100 cubic centimeters (cc), more preferably at least 125 cc, still more preferably between 125 cc and 500 cc, and most preferably between 150 cc and 250 cc. For the purposes of this specification and appended claims, where a portion of a monocular unit resides within the goggle body interior, goggle volume is measured or calculated as if the monocular unit were not present.

FIG. 2 illustrates the goggle body 110 of the first embodiment binocular goggles with the monocular units absent. Engagement ridges 112 that facilitate coupling the monocular units to the goggle body 110 are visible in FIG. 2. Vents are not shown in FIG. 2. When installed on the goggle body 110, the image transfer assembly 125 of each monocular unit 120 extends forwardly about 30 mm from the engagement ridges. Monocular units extend forwardly from the goggle body preferably less than 125 mm, more preferably less than 90 mm, still more preferably less than 60 mm, and most preferably less than 40 mm.

### Second Embodiment Binocular Goggles

Second embodiment binocular goggles 200 are illustrated in FIGS. 3-6. The second embodiment binocular goggles 200 comprise a goggle body 210, including a goggle interior cavity 233 within which resides two monocular units 220. The goggles 200 further include an elastic, adjustable, head strap 228. The goggle body 210 includes an outer housing 212 and an inner frame 213. The inner frame 213 includes a contact perimeter 230 configured to rest or press against a user's face. In some embodiments, a foam strip resides along the contact perimeter to assist conforming the goggle body 210 to a user's face. The inner frame 213 further includes vents 235 for ventilation of the interior cavity.

Each monocular unit 220 of the second embodiment comprises an image transfer assembly 225 and an ocular assembly 226. Each of the second embodiment image transfer assemblies 220 typically, but not necessarily, comprises a reflex minor system employing multiple mirrors and a complex objective lens to direct and focus an image at a focal point proximate the ocular assembly 220. The complex objective lens can include a bi-convex lens cemented to a negative meniscus lens. Variations include image transfer assemblies comprising porro prism systems (including multiple porro prism systems and reverse porro prism systems) and roof prism systems. Porro prism systems are typically, but not necessarily, preferred over roof prism systems because the porro prism systems tend to result in binocular goggles that reside closer to a user's face whose center of gravity is closer to a user's face.

Each ocular assembly 226 is configured to receive light from the image transfer assembly 225 for further image manipulation before transmitting the image through the ocular assembly to a user's eye. Goggle body ports 232 provide an optical path from a goggle exterior into each monocular unit 220.

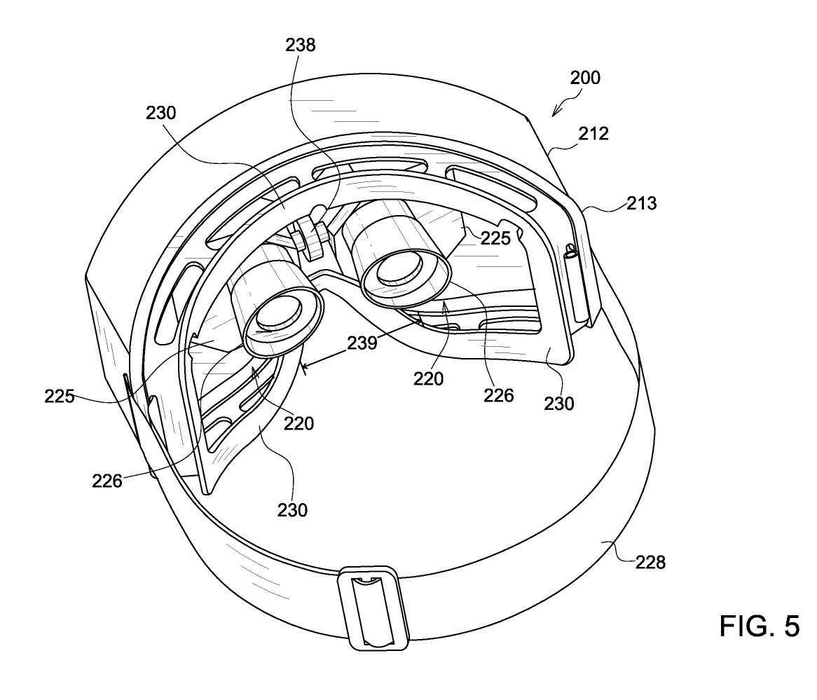

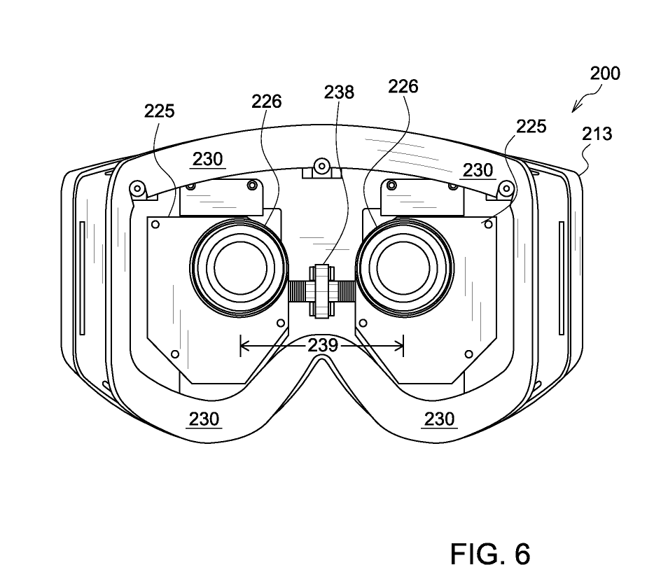

The second embodiment binocular goggles 200 further comprise an ocular width adjustment device 238 configured to adjust an inter-ocular distance 239. Adjustable inter-ocular distance is beneficial for accommodating users having differing inter-pupillary distances. The inter-ocular distance 239 is the distance between centers of of the ocular assemblies 226, as best seen in FIGS. 5 and 6. The inter-ocular distance 239 of the second embodiment is typically adjustable from a maximum of 70 mm to a minimum of 52 mm. Variations include inter-ocular distance that is adjustable from a maximum of 73 mm to a minimum of 48 mm.

In the second embodiment, the ocular width adjustment device 238 typically resides at a fixed location inside the boggle body 210, and operating the device 238 causes both of the monocular units 220 to move, either toward each other (and thus toward the ocular width adjustment device 238), or away from each other and the device 238. The ocular width adjustment device 238 typically, but not necessarily, includes a screw having threaded portions engaging each monocular unit 220 such that turning the screw pulls the monocular units 220 toward the ocular width adjustment device 238, or pushes the units 220 away from the device 238, depending on which direction the screw is turned. In some embodiments, one or both monocular units can be fixed in place on or in the goggle body. Where both monocular units are fixed in place, inter-ocular distance may not be adjustable.

Embodiments of binocular goggles are relatively low mass, which contributes to user comfort. Embodiments have a mass preferably less than 600 grams, more preferably less than 450 grams, still more preferably less than 350 grams, even more preferably less than 300 grams, and most preferably less than 280 grams. The second embodiment binocular goggles have a mass of approximately 445 grams. A variation of the second embodiment that employs lighter materials has a mass of approximately 278 grams.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

Alternative embodiments include binocular goggles in which a monocular unit includes, or is replaced by, a camera system. In some embodiments, each monocular unit includes, or is replaced by, a camera system configured to receive and display an image. The image is typically displayed on a screen or similar display device inside a goggle interior cavity. Camera systems can provide digital magnification of viewed images, in addition to optical magnification provided by camera system optics or monocular unit optics. Variations include a dedicated screen or display device for each of a user's eyes. Embodiments include video capture capability, in which an image or collection of images is recorded for viewing later. The later viewing can be performed on the binocular goggles themselves, or using a computer or other image or video viewing platform.

Variations of binocular goggles according to the present invention include a fan configured to blow air into or out of the goggle interior cavity. The fan can reduce or prevent fogging of lenses inside the interior cavity, and can eliminate fogging that has already occurred. The fan is typically battery powered and controlled by use of a power switch.

I claim:

1. Binocular goggles comprising:
a goggle body including one interior cavity having a volume of at least 100 cubic centimeters (cc); and
two monocular units installed on the goggle body, the two monocular units providing at least 4× magnification.

2. The goggles of claim 1, wherein the goggle is configured to have both of a user's eyes enclosed within the one interior cavity.

3. The goggles of claim 2, wherein each of the two monocular units comprises an image transfer assembly and an ocular assembly.

4. The goggles of claim 3, wherein the device has a mass of less than 450 grams.

5. The goggles of claim 4, wherein the image transfer assembly resides inside the interior cavity.

6. The goggles of claim 5, wherein the goggle body includes two goggle body ports, each of the two goggle body ports providing an optical path from a goggle exterior into the image transfer assembly.

7. The goggles of claim 6, further comprising an ocular width adjustment device configured to adjust inter-ocular distance.

8. The goggles of claims 7, the ocular width adjustment device is anchored in place in the one interior cavity and the ocular assemblies are configured to move relative to the goggle body upon operation of the ocular width adjustment device.

9. The goggles of claim 7, wherein the inter-ocular distance is adjustable from a maximum of 70 mm to a minimum of 52 mm.

10. The goggles of claim 7, wherein the inter-ocular distance is adjustable from a maximum of 73 mm to a minimum of 48 mm.

11. The goggles of claim 7, wherein the goggle body includes vents for ventilating the interior cavity.

12. The goggles of claim 6, wherein the each monocular unit has an exit pupil in a range of 6.0-7.5, inclusive.

13. The goggles of claim 7, wherein the goggle body includes an outer housing to which the monocular units are directly coupled, and an inner frame coupled directly to the outer housing.

14. A method of using the goggles of claim 13 comprising wearing the goggles with both eyes enclosed within the interior cavity and the inner frame residing between the outer housing and the wearer's face.

15. Binocular goggles comprising:
a goggle body including one interior cavity having a volume of at least 125 cubic centimeters (cc) and vents for providing ventilation of the interior cavity;
two monocular units installed on the goggle body, each of the two monocular units providing at least 4× magnification and including an image transfer assembly and an ocular assembly; and
an ocular width adjustment device configured to adjust inter-ocular distance.

16. The goggles of claim 15, wherein the goggle is configured to have both of a user's eyes enclosed within the one interior cavity.

17. The goggles of claim 16, wherein the image transfer assembly is selected from the group consisting of a porro prism system, a roof prism system, and a reflex minor system.

18. The goggles of claim 17, wherein the image transfer assembly includes an objective lens at least 30 mm in diameter. and an exit pupil at least 6.0 mm in diameter.

19. The goggles of claim 17, further comprising an exit pupil at least 6.0 mm in diameter.

20. A method of using the goggles of claim 15 comprising wearing the goggles over eyeglasses.
